(19) United States
(12) Patent Application Publication
(10) Pub. No.: US 2022/0095009 A1
(43) Pub. Date: Mar. 24, 2022

(54) METHOD AND APPARATUS FOR CONTROLLING AUDIO SOUND QUALITY IN TERMINAL USING NETWORK

(71) Applicant: Samsung Electronics Co., Ltd., Suwon-si, Gyeonggi-do (KR)

(72) Inventors: Seungbeom HONG, Suwon-si (KR); Yonghoon LEE, Suwon-si (KR); Sunghwan KO, Suwon-si (KR); Younghyun PARK, Suwon-si (KR); Euisoon PARK, Suwon-si (KR); Junyoung CHO, Suwon-si (KR); Yoongu CHOI, Suwon-si (KR); Hangil MOON, Suwon-si (KR); Hochul HWANG, Suwon-si (KR)

(21) Appl. No.: 17/420,841

(22) PCT Filed: Jan. 8, 2020
(86) PCT No.: PCT/KR2020/000348

§ 371 Date: Jul. 6, 2021

(30) Foreign Application Priority Data
Jan. 9, 2019 (KR) 10-2019-0002951

(51) Int. Cl. H04N 21/439; H04N 21/233; H04N 21/2368; H04N 21/434; G06F 40/30

(52) U.S. Cl. CPC H04N 21/4394; H04N 21/233; G06F 40/30; H04N 21/4341; H04N 21/2368

(57) ABSTRACT

The present invention provides a method and apparatus for performing optimum audio post-processing according to a situation determined according to video information by using the video information using a network connection. The method of a terminal according to the present invention comprises the steps of: acquiring video data to process audio data; transmitting the acquired video-related data to a server; receiving, from the server, data including the audio data subjected to post-processing; and storing data including the audio data subjected to the post-processing, wherein the post-processing is performed on the basis of image data included in the video-related data.

### TECHNICAL FIELD

The disclosure relates to a method and apparatus for controlling an audio sound quality of a terminal and, more specifically, to a method and apparatus for optimizing an audio sound quality of a terminal by using a cloud.

### BACKGROUND ART

Currently, various media devices for individual users have been commercialized, and the types of such media devices may include a portable terminal, a portable audio or video device, a portable personal computer, a portable game device, and a photographing device including a camera and a camcorder. These media devices may provide various media contents to users via a function of communication with a network.

When a currently commercialized media device performs video recording, determination of a recording environment for audio post-processing depends on an input audio signal. However, this only enables a determination that the size of the input signal is large or small, and there is a limitation in performing proper audio post-processing in this manner. Since the media device immediately processes a signal after the signal is received, if an input audio signal suddenly changes as in a case where a quiet environment suddenly changes to a noisy environment, the audio signal is unable to be processed in real time, and it is unavoidable that an attack time occurs before changed audio processing is applied. A sequence of multiple operations for audio post-processing in the media device and parameters applied to the operations are fixed, and thus there is a problem that it is difficult to optimize the audio post-processing depending on a situation.

### DISCLOSURE OF INVENTION

### Technical Problem

The disclosure provides a method and apparatus for performing optimum audio post-processing according to a situation determined according to image information by using the image information using a network connection.

### Solution to Problem

The disclosure for solving the above problems relates to a method for processing audio data by a terminal, the method including: obtaining video data, in which audio data thereof is to be processed; transmitting the obtained video-related data to a server; receiving, from the server, data including the audio data which has been post-processed; and storing the data including the post-processed audio data, wherein the post-processing is performed based on image data included in the video-related data.

The method may further include: receiving a post-processed audio data sample from the server; receiving a user's feedback on the audio data sample; if the user's feedback indicates satisfaction of the user, transmitting the user's feedback to the server, wherein the post-processed audio data received from the server corresponds to all audio data, for which the same post-processing as that for the audio data sample has been performed; if the user's feedback indicates a compensation request, transmitting the user's feedback to the server; and receiving an audio data sample, which has been post-processed in response to the compensation request, from the server.

The video-related data may be the video data or image data of a time period having a predetermined period and the audio data of the video data; a scene may be checked, based on the image data of the video data, in each predetermined time period of the image data, and a post-processing model is determined for each predetermined time period on the basis of the scene; and the post-processing model is a set of a processing sequence of multiple procedures of performing audio post-processing and parameter information on the multiple procedures.

A method for processing audio data by a server includes: receiving video-related data from a terminal; based on image data included in the video-related data, checking a scene in each predetermined time period of the image data; selecting a post-processing model for each predetermined time period, based on the checked scene; post-processing audio data included in the video-related data by means of the selected post-processing model; and transmitting data including the post-processed audio data to the terminal.

The method may further include: generating an audio data sample by means of the selected post-processing model; transmitting the audio data sample to the terminal, wherein the audio data sample includes image data of a predetermined time period and post-processed audio data of the predetermined time period; and receiving a user's feedback from the terminal, wherein if the user's feedback indicates satisfaction of the user, data including the post-processed audio data corresponds to all audio data, for which the same post-processing as that for the audio data sample has been performed.

The method further includes: receiving the user's feedback from the terminal; if the user's feedback indicates a compensation request, re-selecting a post-processing model in response to the compensation request; and post-processing the audio data by means of the re-selected post-processing model.

The video-related data is the video data or image data of a time period having a predetermined period and audio data of the video data; and the post-processing model is a set of a processing sequence of multiple procedures of performing audio post-processing and parameter information on the multiple procedures.

A terminal for processing audio data includes a transceiver, a storage unit, and a controller connected to the transceiver and the storage unit so as to: control the transceiver to obtain video data in which audio data thereof is to be processed, transmit the obtained video-related data to a server, and receive, from the server, data including the audio data which has been post-processed; and control the storage unit to store the data including the post-processed audio data, wherein the post-processing is performed based on image data included in the video-related data.

A server for processing audio data includes a transceiver, and a controller connected to the transceiver so as to control the transceiver to: receive video-related data from a terminal; check a scene in each predetermined time period of the image data, based on image data included in the video-related data; select a post-processing model for each predetermined time period, based on the checked scene; post-process audio data included in the video-related data by means of the selected post-processing model; and transmit data including the post-processed audio data to the terminal, wherein the post-processing model is a set of a processing sequence of multiple procedures of performing audio post-processing and parameter information on the multiple procedures.

### Advantageous Effects of Invention

According to an embodiment of the disclosure, appropriate audio post-processing according to image information can be performed using the image information and, unlike for a terminal, by performing calculation in the server, audio post-processing requiring a complicated calculation procedure can be performed at a high processing speed.

### BRIEF DESCRIPTION OF DRAWINGS

FIG. 1 is a diagram illustrating a block for audio post-processing in a general multimedia recording;

FIG. 2 is a diagram illustrating a magnitude of a signal to which a compressor and an expander of DRC have been applied;

FIG. 3 shows diagrams illustrating a signal to which a limiter of a DRC has been applied;

FIG. 4 is a diagram illustrating an overall configuration of the disclosure;

FIG. 5 is a diagram illustrating a structure of a network including an edge computing server;

FIG. 6 is a diagram illustrating a period and a frame for image data analysis;

FIG. 7 is a diagram illustrating an example of an item selectable based on user feedback;

FIG. 8 is a diagram illustrating an operation of a terminal according to the disclosure;

FIG. 9 is a diagram illustrating an operation of a server according to the disclosure;

FIG. 10 is a block diagram illustrating a structure of a terminal; and

FIG. 11 is a block diagram illustrating a structure of a terminal.

### MODE FOR THE INVENTION

Hereinafter, embodiments of the disclosure will be described in detail in conjunction with the accompanying drawings. In the following description of the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing embodiments of the disclosure in detail, based on determinations by those skilled in the art, the main idea of the disclosure may be applied to other communication systems having similar backgrounds and channel types through some modifications without significantly departing from the scope of the disclosure.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card.

The disclosure provides a method and apparatus for performing audio post-processing that is most optimized for a situation in which a video is captured or reproduced by a media device including one or more microphones and speakers, wherein the media device may include, for example, a portable communication device (a smartphone, etc.), a digital camera, a portable computer device (a laptop, etc.), and the like, and may be interchangeably used with a terminal, and devices to which the disclosure is applied may not be limited to the aforementioned devices. Specifically, the disclosure proposes a method for performing optimal audio post-processing according to a situation determined based on image information by using the image information, and also proposes a scheme of performing audio post-processing in a cloud instead of inside a terminal in order to enable complex operations, etc.

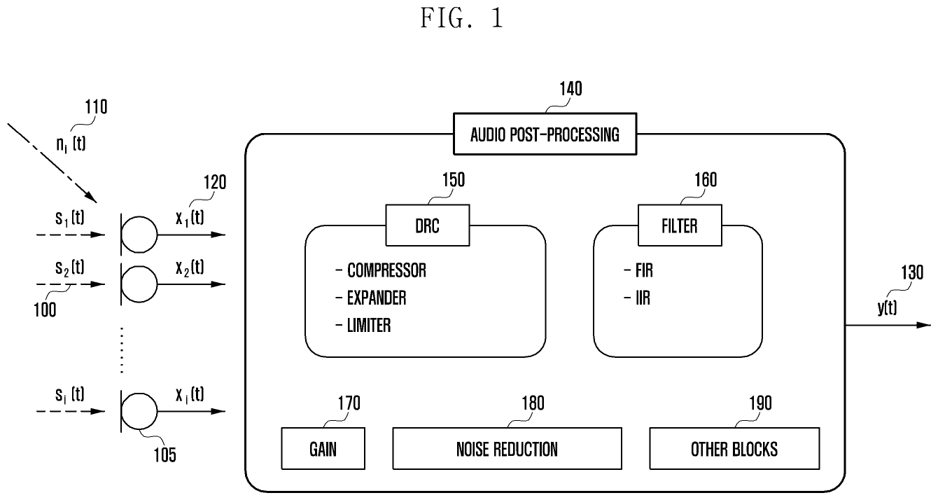

FIG. 1 is a diagram illustrating a block for audio post-processing in a general multimedia recording. According to FIG. 1, a signal sᵢ(t) 100 to be obtained during recording and a noise signal nᵢ(t) 110 are obtained together via each microphone 105, and an input signal xᵢ 120 may be expressed as x_{I}=sᵢ+nᵢ.

Audio post-processing 140 includes various sub-blocks, wherein, in general, these sub-blocks include a dynamic range control (DRC) 150, a filter 160, and noise reduction 180, a gain 170, other blocks 190, and the like. The DRC 150 dynamically changes a magnitude of an output signal according to a magnitude of an input signal, and may include a compressor, an expander, and a limiter. The filter serves to obtain a signal of a desired frequency, and this may include a finite impulse response (FIR) filter and/or an infinite impulse response (IIR) filter. Noise reduction reduces noise that is input with an input signal, and the gain controls an output magnitude. The audio post-processing 140 outputs input signal xᵢ as desired signal y(t) 130 via post-processing.

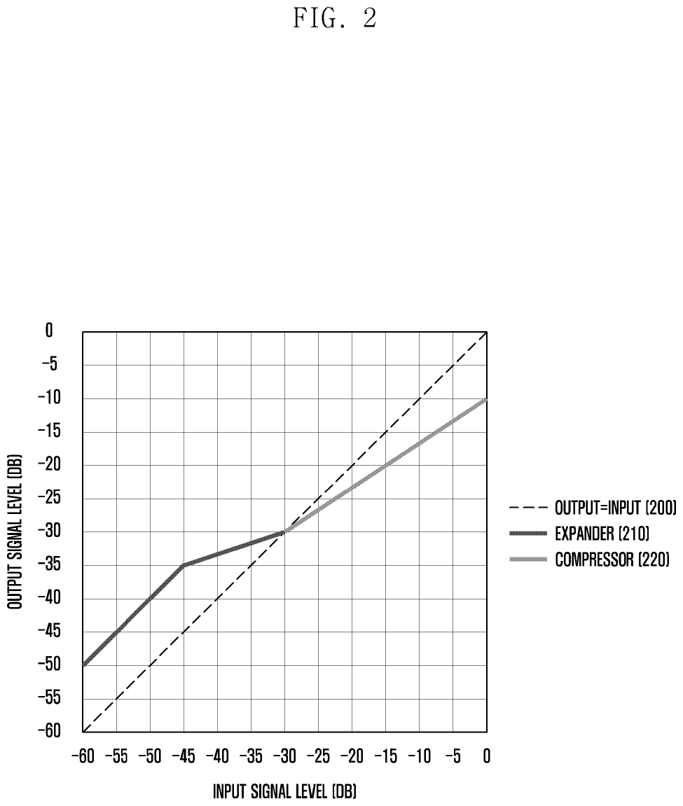

FIG. 2 is a diagram illustrating a magnitude of a signal to which a compressor and an expander of DRC have been applied. The compressor outputs an output signal to be smaller than an input signal, and is mainly used when a signal with a large magnitude is input. The expander outputs an output signal to be larger than an input signal, as opposed to the compressor, and is mainly used when a signal with a small magnitude is input. According to FIG. 2, when a magnitude of an input signal 200 is small, the expander is applied to increase a magnitude of an output signal 210, and when the input signal 200 has a large magnitude, the compressor is applied to reduce the magnitude of the output signal 220.

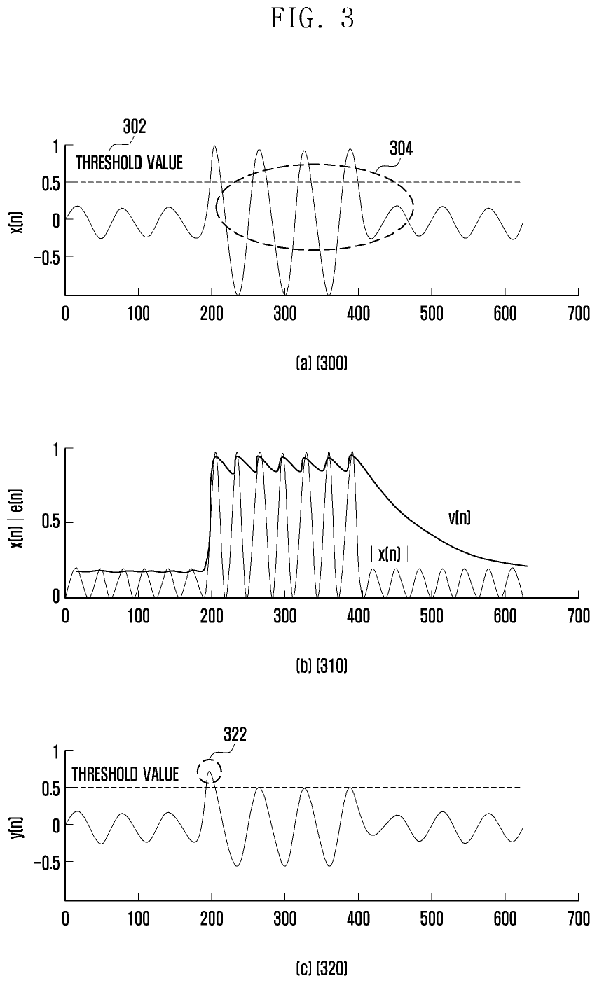

FIG. 3 shows diagrams illustrating a signal to which a limiter of a DRC has been applied. The limiter is used to prevent clipping (clipping is a phenomenon occurring when an allowable input limit or output limit of a device is exceeded, wherein if clipping occurs, a sound quality may be degraded) which corresponds to a case where a sound greater than a magnitude acceptable by a microphone is input. Clipping 304 may occur when a signal with a magnitude greater than a configured threshold value 302 is input, as in (a) 300 in FIG. 3. In this case, a peak is estimated based on an input signal according to (b) 310, and the limiter is applied to reduce a signal magnitude to a value equal to or smaller than the threshold value, as in (c) 320. However, in this case, when a media device performs audio post-processing in real time, it takes time to apply changed audio processing, and a signal with a magnitude exceeding the threshold value may be thus generated 322. This time is referred to as an attack time.

During audio post-processing, depending on each optimization method, there may be a difference in a processing sequence of sub-blocks, applied parameters (e.g., parameters related to signal magnitude adjustment by the compressor or expander, and a frequency band processed by the filter), and the like. When a signal is input, audio signals are sequentially processed according to a method determined by a manufacturer, and at this time, optimization parameters of respective sub-blocks are uniformly applied.

In a currently commercialized media device, determination of a recording environment for audio post-processing relies only on an input audio signal. For example, when an audio signal with a large magnitude comes in via the microphone, the limiter and the compressor are applied to prevent clipping and, in a quiet environment, the expander is applied, and noise reduction is performed to remove noise with increasing magnitude. However, according to such a method, the media device may only determine whether an input magnitude is large or small, and there is a limitation in determining various situations in which recording is performed. The media device performs signal processing in real time after a signal comes in and, therefore, when the input audio signal suddenly changes, such as a sudden change from a quiet environment to a noisy environment, it may take time (attack time) to apply changed audio processing. Parameters and an operation sequence of multiple sub-blocks, for audio post-processing are fixed, and it may be thus difficult to perform optimized audio post-processing according to a situation.

Therefore, an aspect of the disclosure is to obtain information on a recording situation by using image information, and adaptively perform, based on the obtained information, audio signal processing optimization according to various environments, so as to provide an optimal sound quality to a user. To this end, limitations of a portable terminal, such as computing capacity, memory, battery, etc., may be overcome by using a cloud and a deep neural network (DNN) for audio post-processing, and a cloud server may continuously learn an optimal post-processing method and may generate a result optimized for the user. When the terminal performs post-processing of the audio signal, there are many restrictions for performing audio post-processing in real time while video recording or reproduction is being concurrently performed. However, when such post-processing is performed in the cloud, it is possible to identify raw data of all audio signals and then perform optimized audio post-processing for each period, so that it is advantageous in securing an optimal sound quality. The disclosure may also be applied to video reproduction as well as video recording using the media device.

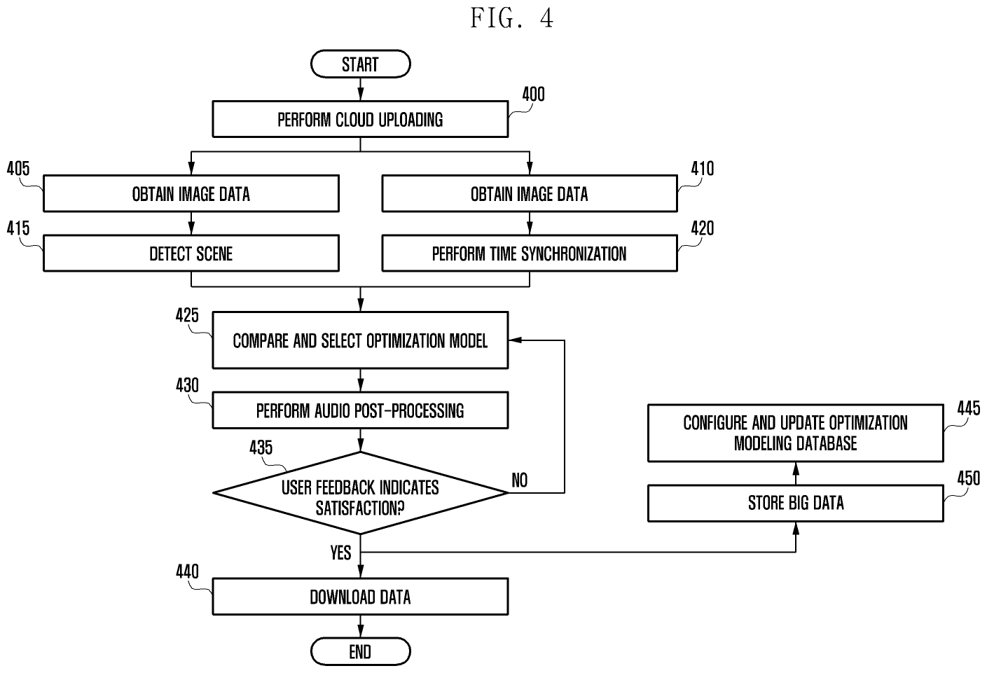

FIG. 4 is a diagram illustrating an overall configuration of the disclosure. According to FIG. 4, the following operations may be performed for the disclosure.

A terminal uploads 400 a captured video or a video to be reproduced from the terminal to a cloud server according to a user's selection. The terminal may upload all video data, but may transmit only audio data in full upon necessity, and in a case of image information having a relatively large data size, image data extracted from each predetermined frame may be uploaded to the cloud server. When a signal processed by the server is transmitted from the terminal to the server or from the server to the terminal, the signal may be processed in the server and then transmitted to the terminal, by using a cloud server in a 5th generation mobile communication (hereinafter, 5G) network or using an edge computing (a computing device located close to the terminal used by the user) server within a base station closest to the terminal.

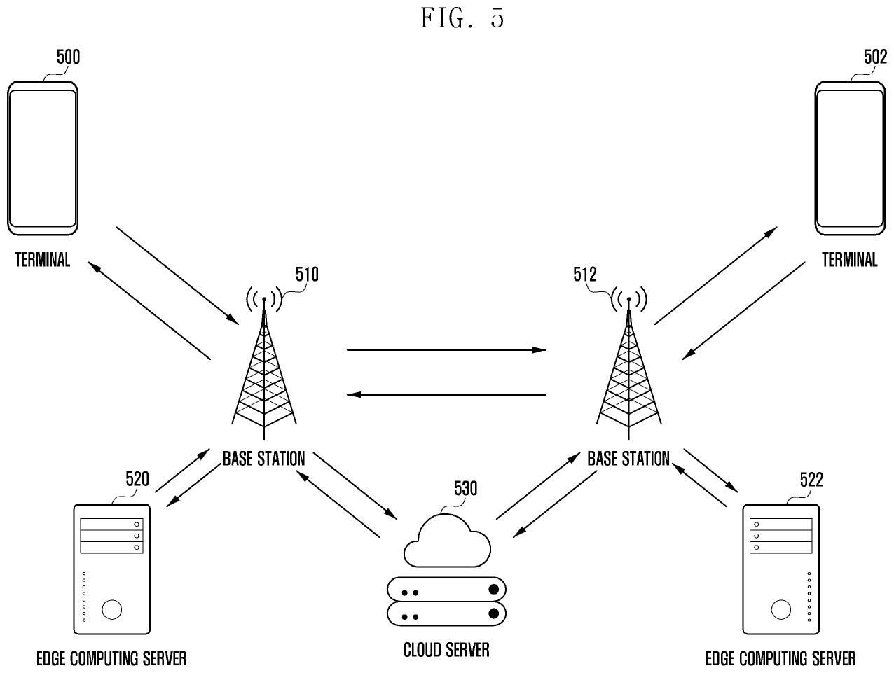

FIG. 5 is a diagram illustrating a structure of a network including an edge computing server. Terminals 500 and 502 are connected to base stations 510 and 512 respectively, and edge computing servers 520 and 522 are connected to the base stations respectively. Each base station may also be connected to a cloud server 530. In a case of using the 5G system, a transmission delay with the base station is 5 ms based on end-to-end (E2E) and about 1 ms based on a wireless interface in the 5G network, so that the transmission delay may be dramatically improved compared to a case of the 4th generation mobile communication system. Therefore, the terminal may use edge computing that uses a server in the base station, in order to preform faster processing or upload video by using the 5G network. The edge computing uses an edge computing server within a radius of the base station, and optimized audio post-processing is thus possible at a high speed, so that a service may be greatly improved. In the disclosure, a server may refer to a cloud server or/and an edge computing server.

Thereafter, the server obtains 405 image data, such as image information obtained from a video uploaded by the terminal or an image file uploaded by the terminal, and obtains 410 audio data such, as an audio signal obtained from the video uploaded by the terminal or an audio file uploaded by the terminal. Thereafter, the server analyzes a scene on the basis of the uploaded image data, and determines the scene related to the image data. A type of the scene may include concert halls, outdoors, indoors, offices, beaches, and the like, which may be determined based on location and/or time. The type of the scene may be predetermined, in which case, a scene considered to be most relevant to the image data may be selected from among predetermined scenes. As in the above, a procedure of determining a scene related to the image data may be referred to as scene detection. The server may improve analysis accuracy by continuously learning about scene analysis by using the DNN.

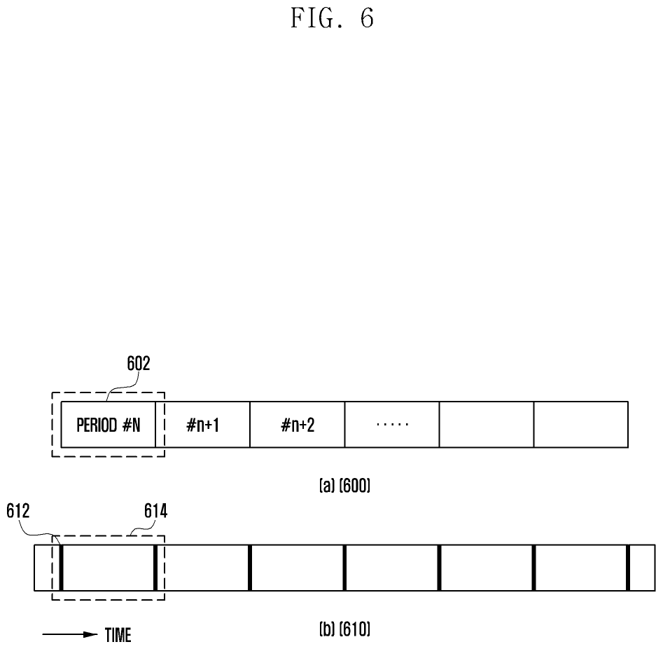

When all image data is uploaded, the server divides the same into periods according to the user's selection or a preconfigured initial value, and analyzes the image data to perform scene detection, and when extracted image data for each predetermined frame is uploaded, the server divides the image data into periods according to a corresponding frame length and analyzes the image data. FIG. 6 is a diagram illustrating a period and a frame for such image data analysis. In a case of (a) 600 of FIG. 6, all image data may be divided into periods 602 according to a certain length of time, and the certain length of time may be configured by a user or may be predetermined. The server analyzes an image for each period and checks a scene corresponding to each period. Scenes corresponding to respective periods may be different. In a case of (b) 610, the server checks a scene corresponding to a period 614, which includes a time corresponding to the image data, based on image data 612 extracted for each predetermined time period.

In addition, the server performs 420 time synchronization of audio data. This refers to synchronization of the audio signal for each period according to the image data analysis period. That is, the synchronization corresponds to checking the audio signal corresponding to a specific time period in which a corresponding scene is determined. This synchronization period may be variably operated according to the image data analysis period. Specifically, the server may divide the audio data according to a length of the specific time period based on an initial time point of the image data and the audio data, and may correspond the divided audio data to each image data analysis period.

The server then makes a comparison 425 of optimization modeling and selects appropriate optimization modeling. The server selects an optimal model by comparing a feature vector (feature vector which may be information indicating a detected scene), which is extracted as a result of scene detection, with feature vectors of respective models in a pre-configured optimization modeling database. For example, if the feature vector is information indicating that a detected scene is a concert hall, the server may select a model, the feature vector of which indicates a concert hall, from among pre-stored models. This model may be a set of operation sequence information of a plurality of sub-blocks for audio post-processing and parameter information for configuration of each operation of the sub-blocks.

When the selected model is changed as a result of scene detection in continuous image data analysis periods, the server may subdivide and analyze the periods. This is because, the change of the selected model is inferred that there must have been a sudden change (for example, a filming location has changed from a concert hall to outdoors, etc.) of a place and time in the video, which may cause the change of the scene within the corresponding image data analysis period, and therefore having the server use a model adapted to the scene change may be more helpful for optimization, compared to having the server continuously use the same model within the same image data for audio post-processing. If a length of an existing image data analysis period is 10 seconds, the server, in this case, may analyze the image data analysis period in units of 2 seconds to detect a scene corresponding to each 2 seconds, and may select a model suitable for the detected scene.

Thereafter, the server performs 430 post-processing of the audio signal, based on the selected optimal model. This post-processing is based on operation sequence information of a plurality of sub-blocks according to the selected model and parameter information for configuration of each operation of the sub-blocks. The audio post-processing may be for all audio data, or may be for a part of the audio data to be provided as a sample to the user.

Thereafter, the server may provide a sample of the audio data, to which the post-processing has been applied, to the user. Before the user downloads all audio data to which the post-processing has been applied, the server may transmit an audio data sample (that is, the audio data sample is downloaded to the terminal), each period of which has been processed, to the user, and the user may confirm the same. Alternatively, the server may provide the user with an audio data sample in which a time period selected by the user has been post-processed. The audio data sample may be provided to the user along with the image data of the corresponding period. For example, the audio data sample may be image data of a partial time period in the entire video, and audio data in which post-processing of the partial time period has been applied. Alternatively, the audio data sample may be audio data in which post-processing of the partial time period in the entire video has been applied.

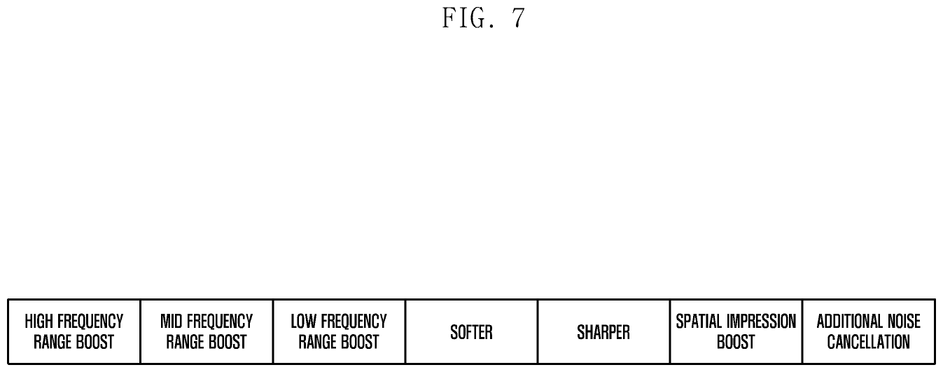

The user who is provided with the audio data sample via the terminal may provide feedback if a processing result is not satisfactory. The user may input 435 an intention indicating satisfaction or may select an insufficient part and input 435 a request for compensation. The request for compensation, which the user can input, may be as shown in FIG. 7. FIG. 7 is a diagram illustrating an example of an item selectable based on user feedback. As in FIG. 7, a user may select one or more insufficient parts from a downloaded sample so as to compensate for the same, and compensation items may include enhancement of a high frequency range (high frequency range boost), enhancement of a mid-frequency range (mid frequency range boost), enhancement of a low frequency range (low frequency range boost), modification of a tone color to be softer or sharper (softer or sharper), enhancement of a spatial impression of sound (spatial impression boost), additional noise cancellation, or the like. The terminal may present the predetermined compensation items to the user via a display, and the user may select at least one of the compensation items. When user feedback is input to the terminal, the terminal may transfer the user feedback to the server.

The server having confirmed the user feedback performs optimization modeling again in consideration of the user feedback, and causes the user to download audio data, which is newly made by applying a newly selected model, so as to perform feedback again. The user feedback may be repeated until the user is satisfied, and a result finally selected by the user is stored 450 as big data in the server and used to determine the user's preference by context (i.e., by scene or by feature vector). If a sufficiently large amount of big data is accumulated, when audio data samples are provided to the user, the server may additionally provide an audio data sample, which has been post-processed, by actively using a model with a high user preference. For example, if a large number of users desire additional noise reduction in a city area, the server may provide the users with an audio data sample, to which a model determined to be optimal modeling has been applied, and an audio data sample obtained by applying additional noise reduction to the audio data sample.

Thereafter, the server transmits 440, to a portable terminal of the user, post-processed audio data to which the same post-processing as that applied to the sample, for which the user has expressed the intention indicating satisfaction, has been applied. Upon necessity, the server may transmit the entire video including images (that is, transmitting both image data and audio data), or may transmit only audio data so as to enable the user terminal to replace only an audio part of the video. Thereafter, when the entire video is received, the terminal may store the entire video and/or reproduce the video, and when the server transmits only audio data, the terminal may replace only the audio part of the stored video data with the received audio data, so as to store and/or reproduce the video.

For the above operation, the server may configure and update 445 an optimization modeling database. The server configures an optimization model for audio post-processing based on a time envelope characteristic of an audio signal and a feature vector. That is, the server combines and stores the processing sequence of multiple sub-blocks and parameters for respective sub-block so as to enable optimization of the audio signal in various situations, such as concert halls, karaoke, a forest, and exhibition halls. Corresponding models may be trained and updated via the user's feedback and DNN.

It is not necessary to perform all the operations to carry out the disclosure, and some operations may be omitted or performed in a changed sequence. For example, operations of generating an audio data sample to obtain user feedback, transmitting the same to the user terminal, and receiving and applying the user feedback may be omitted.

In the disclosure, an accumulated cloud-based DNN is used, and results of multiple users may be thus used instead of a result of a single user. Specifically, the following operations are possible. Since multiple users rather than a single user perform post-processing for audio data in the server, the server may optimize image and audio data by means of the DNN. Specifically, in a case of a video for a famous place where many photographs are taken, the server may correct a distorted image by using pre-stored images or audio data and may allow focusing of a desired sound so as to be heard more easily. The server may shorten a processing time when the same or similar video or audio signal is uploaded using an optimized result value. The server may improve the user's contents by using a result value additionally learned using video and image data in a social network service (SNS) or a video of a video sharing website. Specifically, the server may correct images or compensate for audio data by using the pre-stored image or audio data.

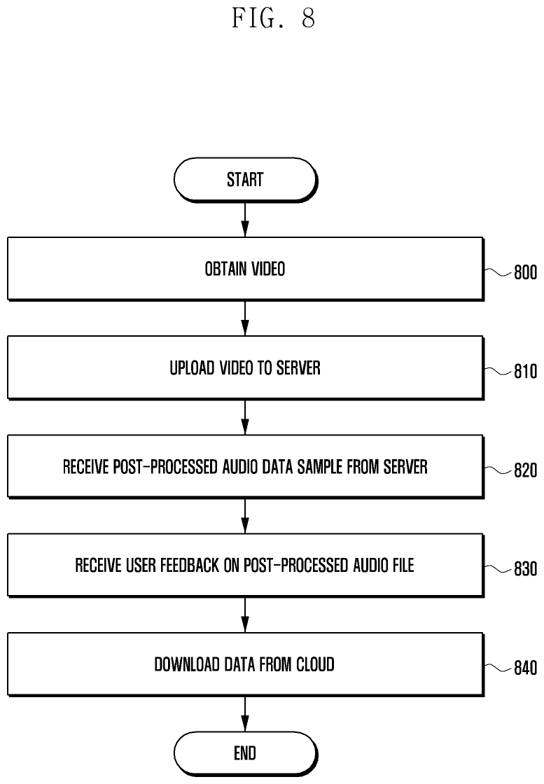

FIG. 8 is a diagram illustrating an operation of a terminal according to the disclosure. According to FIG. 8, a terminal acquires 800 a video required to be post-processed. This may be performed via an operation such as taking a video or downloading a video to be reproduced. Then, the terminal uploads 810 the video to a server. The terminal may upload the entire video, or may upload audio data of the video and a still image file of a specific time period of the video. Then terminal receives 820, from the server, one or more audio data samples to which post-processing gas been applied. Then, the terminal checks feedback on the audio data sample, to which post-processing has been applied, wherein the feedback is input by a user. The feedback may be to select one of multiple audio data samples or to input 830, to the terminal, an item to be compensated for in the audio data samples. The terminal transmits feedback information to the server and downloads 840 data according to the feedback. Specifically, if the terminal has received user feedback for selecting a specific audio data sample, the server may extensively apply the post-processing, which has been applied to the specific audio data sample, to all audio data, and the terminal receives, from the server, data to which the same post-processing has been applied. Alternatively, if the terminal has received user feedback for requesting to compensate for the audio sample, the server generates an audio data sample by applying a user-requested compensation item and performing post-processing again, and the terminal receives the audio data sample from the server. These procedures may be repeatedly performed until the terminal receives feedback indicating user satisfaction.

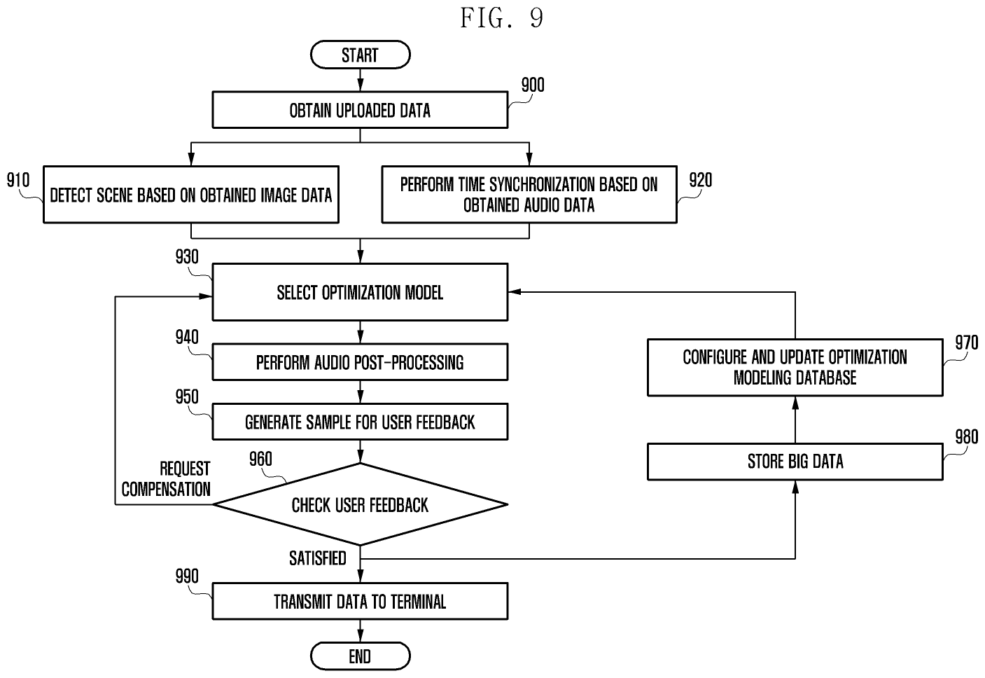

FIG. 9 is a diagram illustrating an operation of a server according to the disclosure. According to FIG. 9, a server acquires 900 data uploaded from a terminal. The data may be the entire video or audio data of the video and a still image file of a specific time period of the video. Then, the server detects 910 a scene according to a time period on the basis of the acquired image data, and synchronizes 920 the acquired audio data with the time period.

Then, the server selects 930 an optimization model for post-processing of the audio data, based on an optimization modeling database, and performs 940 audio post-processing by applying parameters and a processing sequence of sub-blocks according to the model. Then, the server provides 950 one or more audio data samples to the terminal, and checks 960 feedback on the samples. If the user feedback indicates the user's satisfaction for audio post-processing or indicates a satisfactory audio data sample, the server transmits 990 the entire data, to which post-processing has been applied, to the terminal. The user feedback may be stored in the server. When the user requests compensation for the audio data sample, the server selects a new optimization model, performs post-processing of the audio data accordingly, and transmits the audio data sample to the terminal. These procedures may be repeatedly performed until feedback indicating user satisfaction is received.

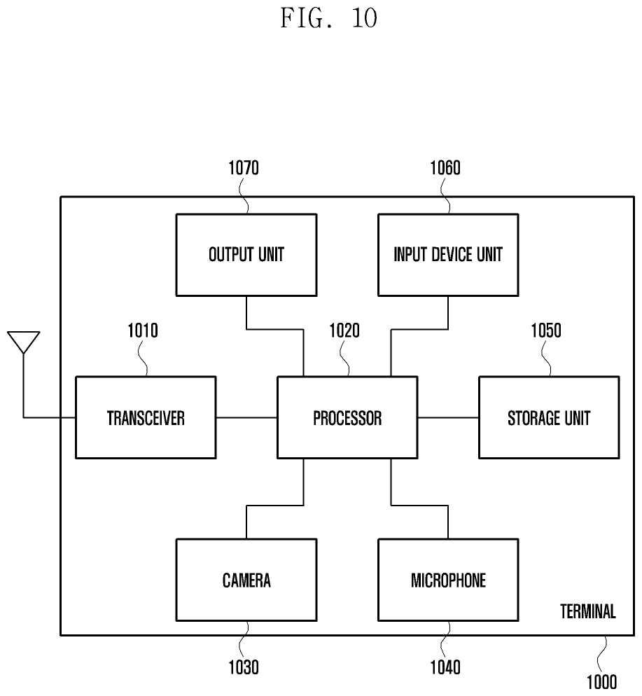

FIG. 10 is a block diagram illustrating a structure of a terminal. According to FIG. 10, a terminal 1000 may include a transceiver 1010, a processor 1020, a camera 1030, a microphone 1040, a storage unit 1050, an output unit 1070, and an input device unit 1060, and is not limited thereto. The transceiver 1010 is a device that supports a communication connection of the terminal and an external device (e.g., a base station or a server, etc.), and may include an RF transmitter that up-converts and amplifies a frequency of a transmitted signal, an RF receiver that performs low-noise amplification of a received signal and down-converts a frequency, and the like. The storage unit 1050 may include a memory capable of storing control information and data, and the output unit 1070 may include a display that outputs an image and a speaker that outputs sound. The input device unit 1060 may include various sensors capable of sensing an external state and, in particular, may include a touch panel that senses a user's touch, etc.

The processor 1020 may include one or more processors, and may control the transceiver 1010, the camera 1030, the microphone 1040, the storage unit 1050, the output unit 1070, the input device unit 1060, and the like so as to carry out the disclosure. Specifically, the processor 1020 may control the camera 1030 and the microphone 1040 to record a video, and may perform a control to transmit a video stored in the storage unit 1050 to the server via the transceiver 1010. The processor 1020 may control the transceiver 1010 to receive an audio data sample from the server, may output a predetermined example of feedback for the audio data sample via the output unit 1070, and may perform a control to check user feedback via the input device unit 1060. The processor 1020 may perform a control to output, via the output unit 1070, final video data received from the server.

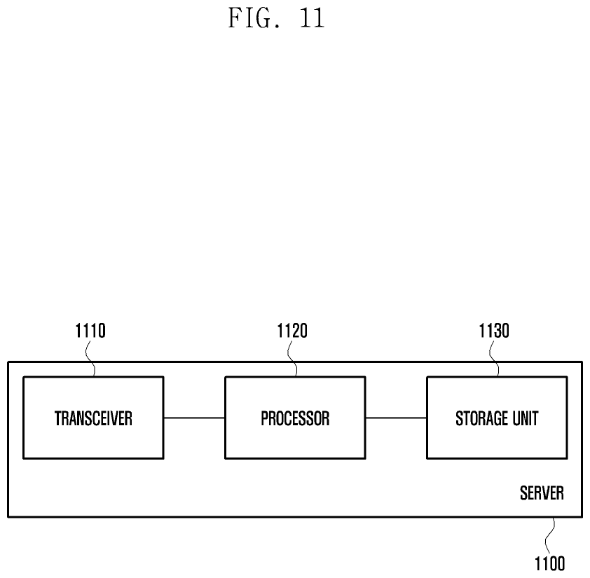

FIG. 11 is a block diagram illustrating a structure of a server. Referring to FIG. 11, a server 1100 may include a transceiver 1110, a processor 1120, and a storage unit 1130. The transceiver 1110 is a device that supports a communication connection of the server and an external device, and may include an RF transmitter that up-converts and amplifies a frequency of a transmitted signal, an RF receiver that performs low-noise amplification of a received signal and down-converts a frequency, and the like. The storage unit 1130 may include a memory capable of storing control information and data, and the processor 1120 controls the transceiver 1110 and the storage unit 1130 so as to carry out the disclosure, and may include a codec capable of processing a video.

The processor 1120 controls the transceiver 1110 to receive a video from the terminal, processes audio data according to the received video by the method proposed in the disclosure, generates an audio data sample to transmit the same to the terminal via the transceiver 1110, and controls the transceiver 1110 to receive user feedback information. The processor generates and stores each audio post-processing model, stores feedback information of a number of users, generates an optimal modeling database and stores the same in the storage unit 1130, and updates the optimal modeling database by using the user feedback information and information on a network.

It should be appreciated that various embodiments of the disclosure and the terms used therein are not intended to limit the technological features set forth herein to particular embodiments and include various changes, equivalents, or alternatives for a corresponding embodiment.

1. A method for processing audio data by a terminal, the method comprising:
obtaining video data, in which audio data thereof is to be processed;
transmitting the obtained video-related data to a server;
receiving, from the server, data comprising the audio data which has been post-processed; and
storing the data comprising the post-processed audio data, wherein the post-processing is performed based on image data included in the video-related data.

2. The method of claim 1, further comprising:
receiving a post-processed audio data sample from the server, and
receiving a user's feedback on the audio data sample.

3. The method of claim 2, further comprising:
if the user's feedback indicates satisfaction of the user, transmitting the user's feedback to the server,
wherein the post-processed audio data received from the server corresponds to all audio data, for which the same post-processing as that for the audio data sample has been performed.

4. The method of claim 2, further comprising:
if the user's feedback indicates a compensation request, transmitting the user's feedback to the server, and
receiving an audio data sample, which has been post-processed in response to the compensation request, from the server.

5. The method of claim 1, wherein:
a scene is checked, based on the image data of the video data, in each predetermined time period of the image data,
a post-processing model is determined for each predetermined time period on the basis of the scene, and
the post-processing model is a set of a processing sequence of multiple procedures of performing audio post-processing and parameter information on the multiple procedures.

6. A method for processing audio data by a server, the method comprising:
receiving video-related data from a terminal;
checking a scene in each predetermined time period of the image data, based on image data included in the video-related data;
selecting a post-processing model for each predetermined time period, based on the checked scene;
post-processing audio data included in the video-related data by means of the selected post-processing model; and
transmitting data comprising the post-processed audio data to the terminal, wherein the post-processing model is a set of a processing sequence of multiple procedures of performing audio post-processing and parameter information on the multiple procedures.

7. The method of claim 6, further comprising:
generating an audio data sample by means of the selected post-processing model, and
transmitting the audio data sample to the terminal, wherein the audio data sample comprises image data of a predetermined time period and post-processed audio data of the predetermined time period.

8. The method of claim 7, further comprising:
receiving a user's feedback from the terminal, wherein:
if the user's feedback indicates satisfaction of the user, data comprising the post-processed audio data corresponds to all audio data, for which the same post-processing as that for the audio data sample has been performed,
if the user's feedback indicates a compensation request, re-selecting a post-processing model in response to the compensation request, and
post-processing the audio data by means of the re-selected post-processing model.

9. A terminal for processing audio data, the terminal comprising:
a transceiver;
a storage unit; and
a controller connected to the transceiver and the storage unit so as to:
control the transceiver to obtain video data in which audio data thereof is to be processed,
transmit the obtained video-related data to a server, and receive, from the server, data comprising the audio data which has been post-processed, and
control the storage unit to store the data including the post-processed audio data, wherein the post-processing is performed based on image data included in the video-related data.

10. The terminal of claim 9, further comprising:
an input device unit, wherein the controller:
controls the transceiver to receive, from the server, an audio data sample which has been post-processed, and
further controls the input device unit to receive a user's feedback on the audio data sample.

11. The terminal of claim 10, wherein:
if the user's feedback indicates satisfaction of the user, the controller further controls the transceiver to transmit the user's feedback to the server, and
the post-processed audio data received from the server corresponds to all audio data, for which the same post-processing as that for the audio data sample has been performed.

12. The terminal of claim 10, wherein if the user's feedback indicates a compensation request, the controller transmits the user's feedback to the server, and further controls the transceiver to receive an audio data sample, which has been post-processed in response to the compensation request, from the server.

13. The terminal of claim 9, wherein:
a scene is checked, based on the image data of the video data, in each predetermined time period of the image data;
a post-processing model is determined for each predetermined time period on the basis of the scene; and
the post-processing model is a set of a processing sequence of multiple procedures of performing audio post-processing and parameter information on the multiple procedures.

14. A server for processing audio data, the server comprising:
a transceiver; and
a controller connected to the transceiver so as to control the transceiver to:
receive video-related data from a terminal,
check a scene in each predetermined time period of the image data, based on image data included in the video-related data,
select a post-processing model for each predetermined time period, based on the checked scene,
post-process audio data included in the video-related data by means of the selected post-processing model, and
transmit data comprising the post-processed audio data to the terminal, wherein the post-processing model is a set of a processing sequence of multiple procedures of performing audio post-processing and parameter information on the multiple procedures.

15. The server of claim 14, wherein:
the controller generates an audio data sample by means of the selected post-processing model, and further controls the transceiver to transmit the audio data sample to the terminal, and
the audio data sample comprises image data of a predetermined time period and post-processed audio data of the predetermined time period.

16. The method of claim 1, wherein the video-related data is the video data or image data of a time period having a predetermined period and audio data of the video data.

17. The method of claim 6, wherein the video-related data is the video data or image data of a time period having a predetermined period and audio data of the video data.

18. The terminal of claim 9, wherein the video-related data is the video data or image data of a time period having a predetermined period and audio data of the video data.

19. The server of claim 14, wherein:
the controller further controls the transceiver to receive a user's feedback from the terminal,
if the user's feedback indicates satisfaction of the user, data including the post-processed audio data corresponds to all audio data, for which the same post-processing as that for the audio data sample has been performed, and
the controller further controls the transceiver to receive the user's feedback from the terminal, and if the user's feedback indicates a compensation request, the controller further performs a control to re-select a post-processing model in response to the compensation request, and post-process the audio data by means of the re-selected post-processing model

20. The server of claim 14, wherein the video-related data is the video data or image data of a time period having a predetermined period and audio data of the video data.
